(19) United States
(12) Patent Application Publication
(10) Pub. No.: US 2016/0170264 A1
(43) Pub. Date: Jun. 16, 2016

(54) LIGHT GUIDING PLATE, OPTICAL FILMS, BACKLIGHT MODULE, ARRAY SUBSTRATE AND LIQUID CRYSTAL MODULE

(71) Applicant: BOE TECHNOLOGY GROUP CO., LTD., Beijing (CN)

(72) Inventor: Guangkui QIN, Beijing (CN)

(21) Appl. No.: 14/236,260

(22) PCT Filed: Jun. 27, 2013
(86) PCT No.: PCT/CN2013/078215

§ 371 Date: Jan. 30, 2014

(30) Foreign Application Priority Data
Mar. 12, 2013 (CN) 201310077667.7

(51) Int. Cl. G02F 1/1335

(52) U.S. Cl. CPC G02F 1/133606; G02F 1/133524; G02F 1/133611; G02F 1/133603; G02F 1/133605; G02F 2001/133607

(57) ABSTRACT

The embodiments of the present invention provide a light guiding plate, an optical film, a backlight module, an array substrate and a liquid crystal module. A reflective layer and a light collimating layer are formed on one surface of the light guiding plate, the reflective layer is positioned below the light collimating layer and has a plurality of holes. The light from the point light source is collimated by the light collimating layer) to form a parallel lights, so that the lights are incident into the array substrate at the same angle without any lights at other angles. Thus, the same brightness is maintained when viewed from different angles by the users, and the problem of the viewing angle dependency in the TFT-LCD is overcome.

### FIELD

Embodiments of present invention relate to a display technology field, more particularly, to a light guiding plate, an optical film, a backlight module, an array substrate and a liquid crystal module.

### BACKGROUND

Thin Film Transistor-Liquid Crystal Display (TFT-LCD) has advantages of small volume, low power consumption, no radiation, etc., so it becomes a dominant product in current flat panel display market. As shown in FIG. 1, the TFT-LCD has a main structure of liquid crystal module which includes an array substrate 1 and a color filter substrate 2 assembled as a cell, and polarized plates 3 and 4 with polarization directions perpendicular to each other disposed on outer sides of the array substrate 1 and the color filter substrate 2 respectively. A displaying principle of the TFT-LCD is described as following. Lights pass through the polarized plate 3 on the outer side of array substrate 1 to form a polarized light. With the TFTs as switching elements, a driving electric field is applied to liquid crystal molecules 5 to control the rotation of the liquid crystal molecules, such that long axes of the liquid crystal molecules 5 have different inclination angles relative to the array substrate 1 so as to display various gray-levels, thus controlling the display of the TFT-LCD.

An image is displayed by using the optical property of the liquid crystal molecules, but such optical property may narrow a viewing angle of the liquid crystal display. Meanwhile, since the liquid crystal molecules have optical anisotropy, the angles between the long axes of the liquid crystal molecules and the array substrate 1 are actually different when displaying different gray-levels. Thus when users view the LCD from different angles, they might see either the long axes or short axes of the liquid crystal molecules, which produce different brightness. That is called as viewing angle dependency of TFT-LCD. Additionally, in theory, when the thin film transistor is turned on, as shown in FIG. 2, the lights pass through the liquid crystal molecules 5 that are vertical to the array substrate 1 but can not pass through the polarized plate 4 on the outer side of the color filter substrate 2. However, the users may actually see the long axes of the liquid crystal molecules 5 at certain angles, that is, the transmittance at such certain angles is increased, so that an image with a low gray-level may actually have higher brightness than that with a high gray-level. This is called a gray-level inversion phenomenon which is inherent in the TFT-LCD.

Since the viewing angle property of the liquid crystal is not uniform, the gray-level inversion or color offset becomes serious at the viewing angles other than a normal direction of the display panel. Conventionally, the viewing angle is usually improved by using a wide viewing angle mode or using a compensation film to compensate the view angle. However, the above two methods can not solve the viewing angle problem of TFT-LCD. The problem to be solved by embodiments of the present invention is how to obtain a backlight source which collimates the light at a higher degree, which can eliminate viewing angle dependency issue.

### SUMMARY OF THE INVENTION

To solve the above problem, an embodiment of the present invention provides a light guiding plate. A reflective layer and a light collimating layer are formed on one surface of the light guiding plate. The reflective layer is positioned below the light collimating layer, and the reflective layer is formed with a plurality of holes.

In the light guiding plate described as above, for example, the light collimating layer has a plurality of micro lens structures, the micro lens structures and the holes have a one to one correspondence, and each hole is located at a focus point of the corresponding micro lens structure.

In the light guiding plate described as above, for example, the light collimating layer has a plurality of prism structures, the holes have a one to one correspondence to the corresponding prism structure.

An embodiment of the present invention provides an optical film comprising a reflective layer and a light collimating layer. The reflective layer is positioned below the light collimating layer, and has a plurality of holes.

In the optical film described as above, for example, the light collimating layer has a plurality of micro lens structures, the micro lens structures and the holes have a one to one correspondence, and each hole is located at a focus point of the corresponding micro lens structure.

In the optical film described as above, for example, the light collimating layer has a plurality of prism structures, and the prism structures and the holes have a one to one correspondence.

Accordingly, an embodiment of the present invention provides a backlight module comprising a light guiding plate and an optical film located on the light guiding plate. The light guiding plate is the light guiding plate described as above, or the optical film is the optical film described as above.

An embodiment of the present invention also provides an array substrate. A light collimating layer and a reflective layer are formed on an outer surface of the array substrate, and the reflective layer is positioned below the light collimating layer and has a plurality of holes.

In the array substrate described as above, for example, the light collimating layer has a plurality of micro lens structures, the micro lens structures and the holes have a one to one correspondence, and each hole is located at a focus point of the corresponding micro lens structure.

In the array substrate described as above, for example, the light collimating layer has a plurality of prism structures, the prism structures and the holes have a one to one correspondence.

Accordingly, an embodiment of the present invention provides a liquid crystal module comprising a backlight module and an array substrate. The backlight module is the backlight module described as above, or the array substrate is the array substrate described as above.

### BRIEF DESCRIPTION OF TI-IE DRAWINGS

FIGS. 1-2 are schematic views showing display principles of the TFT-LCD;

FIGS. 3-4 are schematic views showing operation principles of the present invention;

FIG. 5 is a schematic structure view of a light guiding plate according to an embodiment of the present invention;

FIG. 6 is a schematic structure view of a reflective layer according to the embodiment of the present invention;

FIG. 7 is another schematic structure view of a light guiding plate according to the embodiment of the present invention;

FIG. 8 is a schematic view of a light path along which lights propagate through the reflective layer and a light collimating layer according to the embodiment of the present invention;

FIG. 9 is a schematic structure view of an array substrate according to another embodiment of the present invention;

FIG. 10 is a schematic structure view of an array substrate according to a still another embodiment of the present invention.

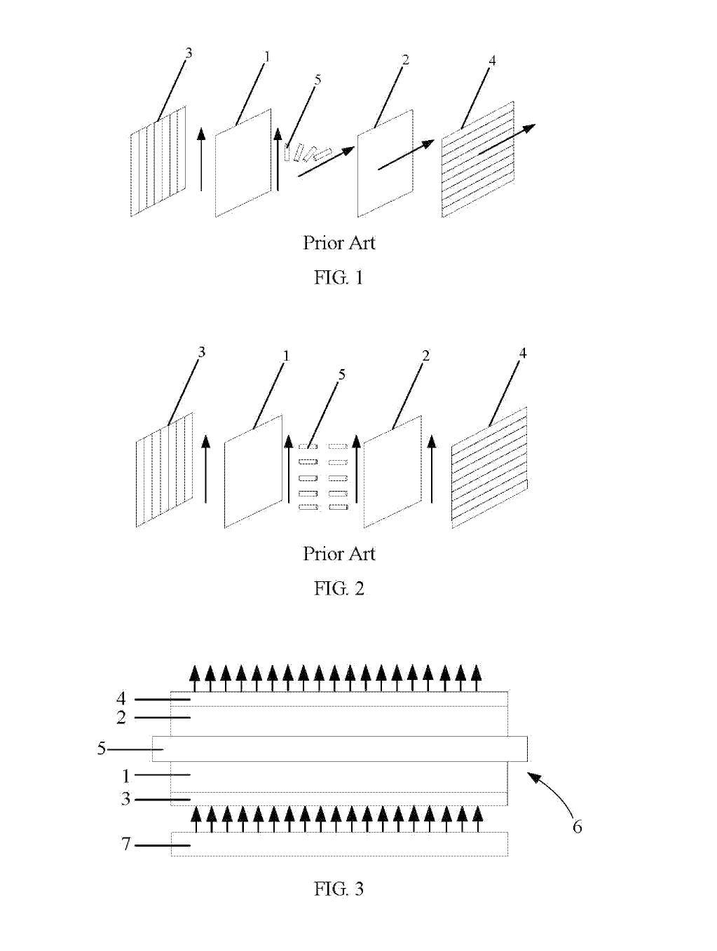

### DESCRIPTION OF THE EMBODIMENTS

Embodiments of the present invention are described in detail in connection with the drawings and the embodiments. The following embodiments are only for the purpose of explaining the present invention but not for a limitation.

It should be understood that spatially relative terms, such as “above” and “below” that are orientation or position relationship of the device shown in FIG. 3, may be used herein for ease of description, but does not indicate or imply that the device or element must be disposed in the particular orientation, or be configured and operated in the particular orientation, so it can not interpreted as a limitation of the present invention. Alternatively, the device or element also can have other orientation or position relationships, such as, the position order of respective devices or elements can be adjusted or exchanged or the like, in which the displaying also can be performed.

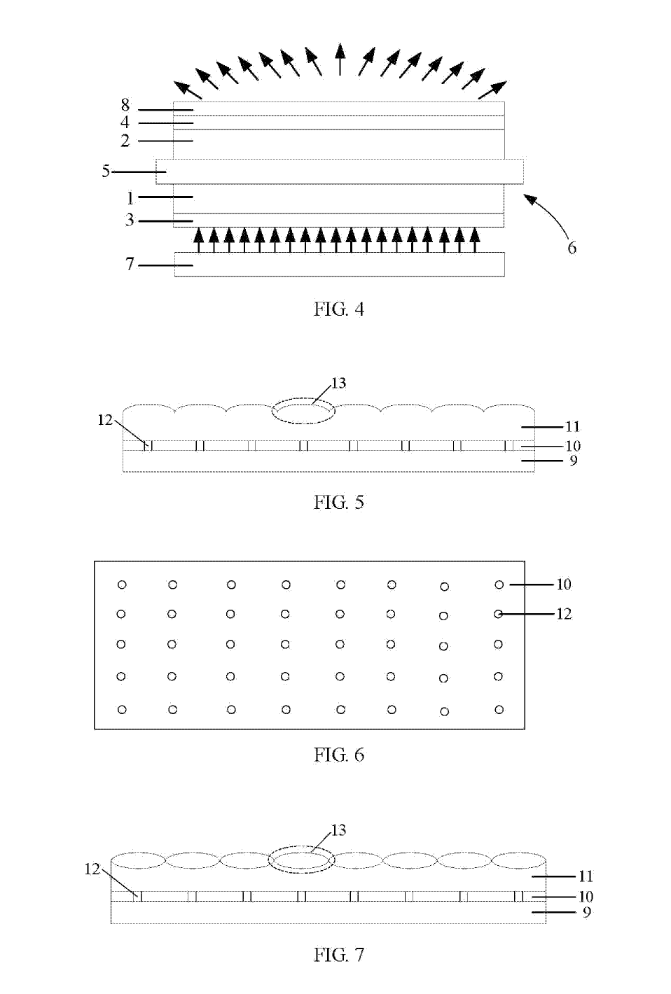

As shown in FIG. 3, in order to overcome the problem of the viewing angle dependency in the TFT-LCD, it is necessary to provide a backlight source 7 with a higher light collimation in order to keep incident lights of the array substrate 1 in parallel at a same certain angle, generally in a direction perpendicular to the array substrate 1 without any incident lights in other directions. The backlight source 7 with higher light collimation can prevent the light leakage caused by different viewing angles. Since the lights viewed from other angles by the users are caused by the light diffusion of lights at the certain angle on a surface of the display panel, the brightness would be the same if viewed at different angles by the users, and the problem of the viewing angle dependency in the TFT-LCD is overcome. In practice, as shown in FIG. 4, an optical film 8 may be disposed at the outside of the liquid crystal module 6 to further increase the viewing angle of the TFT-LCD.

### First Embodiment

As shown in FIGS. 5-7, in order to make the lights incident at the same angle into the array substrate, a light guiding plate 9 is provided in the present embodiment. A reflective layer 10 and a light collimating layer 11 are formed on the light guiding plate 9 by a coating, depositing, sputtering process, etc. The reflective layer 10 is positioned below the light collimating layer 11, and the reflective layer 10 is formed with a plurality of holes 12, so as to form a point light source in each hole 12. The lights from each point light source is collimated by the light collimating layer 11, so that the emitted lights propagate in the same direction, as shown in FIG. 8. In general, the lights are vertically emitted from a surface of the light guiding plate 9.

There are various optical structures which serve to emit parallel light from the point light sources, for example, the optical structure could be a convex lens structure. For example, the light collimating layer 11 may be designed to have a plurality of micro lens structures 13. The micro lens structure 13 may be a planoconvex lens as shown in FIG. 5, or a double convex lens as shown in FIG. 7. The micro lens structures 13 and the holes 12 have a one to one correspondence, and each hole 12 is located at a focus point of the corresponding micro lens structures 13, that is, a vertical distance between the corresponding hole 12 and the micro lens structure 13 may be the focus length of the lens. The focus length f of the micro lens structure may be expressed by following formulas: f=r/n₂−n₁ for the planoconvex lens; or

$$f = \frac{1}{( {n}_{2} - {n}_{1} ) * \frac{1}{{r}_{1}} - ( {n}_{1} - {n}_{2} ) * \frac{1}{{r}_{2}}}$$

for the double convex lens, where n₂ is a refractive index of base material of the micro lens structures 13, n₁ is a refractive index of outside atmosphere of the micro lens structures 13, r is a curvature radius of the planoconvex lens, and r₁, r₂ are curvature radii of the double convex lens. Assuming each lens has a width of 100 μm, the curvature radius r is 1 mm, then the focus length f for is 1 mm for a planoconvex lens. That is, the vertical distance between the corresponding hole 12 and the center of the corresponding micro lens structure 13 is 1 mm. The focus length f can be 2 mm for a double convex lens assuming the same parameters. That is, the vertical distance between the corresponding hole 12 and the center of the corresponding micro lens structure is 2 mm.

Meanwhile, since the reflective layer 10 and the light collimating layer 11 are formed on the light guiding plate 11 as an integral structure, the whole structure is stable.

### Second Embodiment

In order to make the light incident into an array substrate at the same angle, an optical film is provided between a light guiding plate and the array substrate in the present embodiment. The optical film comprises a reflective layer and a light collimating layer, and the reflective layer is positioned below the light collimating layer, and the reflective layer is formed with a plurality of holes. Also, the light collimating layer may be designed to have a plurality of micro lens structures. The micro lens structures and the holes in the reflective layer have a one to one correspondence, and each hole are located at a focus point of the corresponding micro lens structure, so that the lights are emitted in parallel from the light collimating layer, and then is incident to the array substrate at the same angle.

### Third Embodiment

A liquid crystal module is provided in the present embodiment. The liquid crystal module comprises a light guiding plate and an optical film on the light guiding plate. The light guiding plate can be the light guiding plate according to the first embodiment, or the optical film can be the optical film according to the second embodiment, so that the lights are incident perpendicular into the array substrate 1 at the same angle, and thus the light leakage caused by different viewing angles can be prevented. Since the lights viewed from other angles by the users is obtained by diffusing the lights having the same incident angle at a surface of the display panel, the same brightness may be maintained when viewed from different angles by the users, and the problem of the viewing angle dependency in the TFT-LCD can be overcome.

### Fourth Embodiment

In order to make the lights incident into the array substrate at the same angle, a light collimating layer and a reflective layer also may be formed on an outer surface of the array substrate.

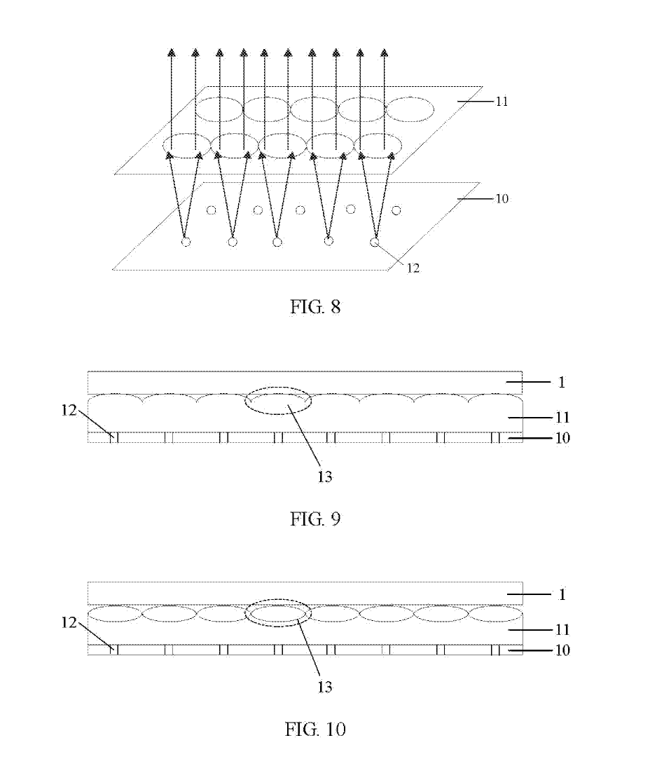

Referring to FIGS. 9-10, the present embodiment provides an array substrate which is formed with a reflective layer 10 and a light collimating layer 11 on an outer surface thereof for example by a coating, depositing, sputtering process or the like. The reflective layer 10 and the light collimating layer 11 are formed on the outer surface of the array substrate 1 that is adjacent to the light guiding plate. The reflective layer 10 is positioned below the light collimating layer 11, and the reflective layer 10 is formed with a plurality of holes 12, so as to form a point light source in each hole 12. The lights from each point light source is collimated by the light collimating layer 11, so that the emitted lights propagate in the same direction, and then are incident in parallel into the array substrate 1. In general, the lights are vertically incident to a surface of the array substrate 1.

There are various optical structures for emitting lights in parallel from the point light sources, for example, a convex lens structure. The light collimating layer 11 may be designed to have a plurality of micro lens structures 13, for example. The micro lens structure 13 may be a planoconvex lens as shown in FIG. 9, or may be double convex lens as shown in FIG. 10. The micro lens structures 13 and the holes 12 have a one to one correspondence, and each hole 12 is located at a focus point of the corresponding micro lens structure 13. That is, a vertical distance between the corresponding hole 12 and the micro lens structures 13 may be the focus length f of the lens.

Meanwhile, since the reflective layer and the light collimating layer are formed on the array substrate as an integral structure, the integral structure is stable.

### Fifth Embodiment

A liquid crystal module is provided in the present embodiment. The liquid crystal comprises a backlight module and an array substrate. The backlight module is the backlight module according to the third embodiment, or the array substrate is the array substrate according to the fourth embodiment, so that the lights are incident to the array substrate 1 at the same angle without any lists at other angles, thus the light leakage caused by different viewing angles can be prevented. Since the lights viewed from other angles by the users are obtained by diffusing the lights having the same incident angle at a surface of the display panel, the same brightness may be maintained when viewed from different angles by the users, and the problem of the viewing angle dependency in the TFT-LCD is overcome.

The embodiments of the present invention provide the light guiding plate, the optical film, the backlight module, the array substrate and the liquid crystal module, which may be used to obtain the backlight source with a higher light collimation. A surface light source having the parallel lights emitted is provided, so that the parallel lights are incident into the array substrate at the same angle without any lights at other angles, thus the light leakage caused by different viewing angles can be prevented. Since the lights viewed from other angles by the users are obtained by diffusing the light having the same incident angle at a surface of the display panel, it overcomes the problem of the viewing angle dependency in the TFT-LCD.

It is noted that the embodiments of the present invention only describe the convex lens structure as an example in order to explain how to obtain parallel lights emitted from a point light source by the light collimating layer, but it is not a limitation. The light collimating layer may have other structures, e.g., prism structures having a one to one correspondence with a plurality of holes, as long as they can collimate the lights from the point light source and then emit the parallel lights.

The above embodiments provide the light guiding plate, the optical film, the backlight module, the array substrate and the liquid crystal module, in which the reflective layer and the light collimating layer are formed between the light guiding plate and the array substrate, the reflective layer is positioned below the light collimating layer, and the reflective layer is formed with a plurality of holes, so as to form a point light source in each hole. The light from each point light source is collimated by the light collimating layer so as to form the parallel lights, so that the lights are incident to the array substrate at the same angle without any lights at other angles. Thus, a backlight source with a higher light collimation for the TFT-LCD is provided, and the light leakage caused by different viewing angles can be prevented. Since the lights viewed from other angles by the users are obtained by diffusing the lights having the same incident angle at a surface of the display panel, the same brightness may be maintained when viewed from different angles by the users, and the problem of the viewing angle dependency in the TFT-LCD is overcome.

It should be noted that: the above description only describes the embodiments of the present invention, those skilled in the art should understand that change and alternation can be made in the solutions of the invention without depart from the spirit and scope of the invention, and the change and alternation also fall into the scope of the present invention.

1-11. (canceled)

12. A light guiding plate, wherein a reflective layer and a light collimating layer are formed on one surface of the light guiding plate, the reflective layer is positioned below the light collimating layer, and the reflective layer is formed with a plurality of holes.

13. The light guiding plate according to claim 12, wherein the light collimating layer has a plurality of micro lens structures, the micro lens structures and the holes have a one to one correspondence, and each hole is located at a focus point of the corresponding micro lens structure.

14. The light guiding plate according to claim 12, wherein the light collimating layer has a plurality of prism structures, and the prism structures and the holes have a one to one correspondence.

15. An optical film comprising a reflective layer and a light collimating layer,
wherein the reflective layer is positioned below the light collimating layer, and has a plurality of holes.

16. The optical film according to claim 15, wherein the light collimating layer has a plurality of micro lens structures, the micro lens structures and the holes have a one to one correspondence, and each hole is located at a focus point of the corresponding micro lens structure.

17. The optical film according to claim 15, wherein the light collimating layer has a plurality of prism structures, and the prism structures and the holes have a one to one correspondence.

18. A backlight module comprising a light guiding plate and an optical film located on the light guiding plate,
wherein a reflective layer and a light collimating layer are formed on one surface of the light guiding plate, the reflective layer is positioned below the light collimating layer, and the reflective layer is formed with a plurality of holes, or
the optical film comprises a reflective layer and a light collimating layer,
wherein the reflective layer is positioned below the light collimating layer, and has a plurality of holes.

19. The backlight module according to claim 18, wherein the light collimating layer formed on the surface of the light guiding plate has a plurality of micro lens structures, the micro lens structures and the holes have a one to one correspondence, and each hole is located at a focus point of the corresponding micro lens structure.

20. The backlight module according to claim 18, wherein the light collimating layer formed on the surface of the light guiding plate has a plurality of prism structures, and the prism structures and the holes have a one to one correspondence.

21. The backlight module according to claim 18, wherein the light collimating layer of the optical film has a plurality of micro lens structures, the micro lens structures and the holes have a one to one correspondence, and each hole is located at a focus point of the corresponding micro lens structure.

22. The backlight module according to claim 18, wherein the light collimating layer of the optical film has a plurality of prism structures, and the prism structures and the holes have a one to one correspondence.
